(19) United States
(12) Patent Application Publication
(10) Pub. No.: US 2025/0312936 A1
(43) Pub. Date: Oct. 9, 2025

(54) DEVICE FOR HOLDING A VIBRATING BLADE ON A BLADE HOLDER OF A CUTTING MACHINE, AND BLADE INTENDED TO COOPERATE WITH SUCH A DEVICE

(71) Applicant: LECTRA, Paris (FR)

(72) Inventors: Alexis COQUILLOT, SAINT JEAN DE BLAIGNAC (FR); Didier CHABIRAND, CESTAS (FR); Régis LALLEMENT, CESTAS (FR)

(21) Appl. No.: 18/865,424

(22) PCT Filed: May 11, 2023
(86) PCT No.: PCT/FR2023/050679

§ 371 Date: Nov. 13, 2024

(30) Foreign Application Priority Data
May 13, 2022 (FR) 2204552

(51) Int. Cl. B26D 1/10; B26D 7/08; B26D 7/26

(52) U.S. Cl. CPC B26D 1/105; B26D 7/086; B26D 7/2614

(57) ABSTRACT

A device is for holding a vibrating steel blade on a blade holder of a cutting machine, and includes a blade holder having a notch able to receive an upper end of a blade, means for holding by magnetism the upper end of the blade in the notch of the blade holder along a direction perpendicular to a longitudinal axis of the blade, and at least one lug formed in the notch and able to be housed in a cutout made in the upper end of the blade to ensure an absorption of the cutting forces.

### TECHNICAL FIELD

The present invention relates to the general field of the automatic cutting of a flexible material by a vibrating blade of a cutting machine. It more particularly concerns the holding of the blade on the blade holder of such a cutting machine.

One field of application of the invention is that of the automatic cutting of pieces from a textile or non-textile flexible material (such as leather), particularly in the clothing, furnishing or car upholstery industry.

### PRIOR ART

A known method for automatically cutting pieces from a flexible material consists in bringing the material onto a fixed or movable cutting support of the cutting table, in the form of a single ply or of a stack of plies forming a mattress, and in cutting the pieces by means of a cutting head moving above the cutting support of the table according to a previously defined placement program.

Typically, the cutting head of such a machine comprises a steel blade which is assembled on a blade holder and which is vibrated vertically along the direction of its sharp edge in order to cut the material. A rotating blade guide serves as a slide for the blade and ensures its rotation.

The blade is generally vibrated by a connecting rod-crank system which drives the blade in a back-and-forth translational movement. For example, the translational movement has an amplitude of 25 mm and a vibration frequency of the order of 100 Hz.

Moreover, to ensure the trajectory tracking of the pieces to be cut from the material, it is necessary for the cutting tool to exert a rotational movement of the blade about its longitudinal axis. This rotational movement is generally ensured via the blade guide and the crowbar of the cutting tool.

Typically, in order to allow these translational and rotational movements, the blade is held in position at its upper end in the blade holder by means of one or several assembly screws. The mounting and the dismounting of the blade for replacement are ensured using a tool, for example of the hex wrench type.

Particularly, with this type of assembly, to replace a worn blade, it is necessary to manually access the assembly screw(s) and have a suitable wrench. However, the blade holder of the cutting head of a cutting machine generally has restricted access which may require the prior dismounting of elements of the cutting head. In addition, the appropriate tool must be available and the tightening force to be applied to the screw during the mounting of the new blade is difficult to calibrate. All of these operations therefore involve a considerable loss of time for the users of the cutting machine.

### DISCLOSURE OF THE INVENTION

The main aim of the present invention is therefore to propose a device for holding a vibrating blade on a blade holder of a cutting machine which does not have the aforementioned drawbacks.

In accordance with the invention, this aim is achieved thanks to a device for holding a vibrating steel blade on a blade holder of a cutting machine, comprising:
a blade holder having a notch able to receive an upper end of a blade,
means for holding by magnetism the upper end of the blade in the notch of the blade holder along a direction perpendicular to a longitudinal axis of the blade, and
   at least one lug formed in the notch and able to be housed in a cutout made in the upper end of the blade in order to ensure an absorption of the cutting forces.

The device according to the invention is remarkable in that it provides means for holding by magnetism the upper end of the blade in the notch of the blade holder along a direction perpendicular to a longitudinal axis of the blade (the holding of the blade in the notch of the blade holder is devoid of mechanical attachment). This holding by magnetism ensures transmission of the cutting movement without clearance. Furthermore, the cutting forces related to the back-and-forth translational movement of the blade are absorbed by obstacles resulting from the shape of the interface between the blade and the notch of the blade holder, not by frictional forces.

In addition, the device according to the invention allows mounting and dismounting of the blade on the blade holder without the need to use a specific tool (wrench, screwdriver, etc.). Indeed, the mounting and dismounting of the blade can be done manually. This great case of mounting and dismounting saves considerable time for the users of the cutting machine.

According to one embodiment, the blade holder comprises at least one magnet assembled inside the notch and able to establish a planar bearing with a planar surface of the upper end of the blade so as to ensure holding by magnetism of the upper end of the blade in the notch of the blade holder. This embodiment has the advantage of being simple to implement. Moreover, the planar bearing between the magnet(s) and the blade ensures better holding of the blade.

According to another embodiment, the notch of the blade holder is magnetized so as to ensure holding by magnetism of the upper end of the blade in the notch of the blade holder.

According to still another embodiment, the notch of the blade holder comprises a ferromagnetic metal and the upper end of the blade comprises a magnet so as to ensure holding by magnetism of the upper end of the blade in the notch of the blade holder.

Whatever the embodiment, the notch can comprise a bottom having a planar surface and is delimited laterally by two rims protruding relative to the bottom.

In this case, the lug can extend from a lower end of one of the rims of the notch towards the other rim along a direction substantially perpendicular to the longitudinal axis of the blade. Such a lug has the advantage of ensuring good absorption of the cutting forces while acting as a key for the blade.

Alternatively, the lug can be made by a pin extending from the bottom of the notch along a direction substantially perpendicular to the longitudinal axis of the blade. Such a lug has the advantage of conferring great case in mounting the blade.

The invention also relates to a vibrating steel blade for a cutting machine intended to cooperate with the holding device as defined previously, the blade comprising an upper end able to be housed in the notch of the blade holder and to be held therein by the magnetism holding means, the upper end of the blade comprising at least one cutout able to receive the lug formed in the notch.

Preferably, the blade is made of high-speed steel.

The invention also relates to an assembly of a vibrating steel blade as defined above on a blade holder of a cutting machine via a holding device as defined above.

### BRIEF DESCRIPTION OF THE DRAWINGS

FIG. 1 is a schematic view showing an example of assembly according to the invention of a vibrating blade on a blade holder of a cutting machine.

FIGS. 2A and 2B are a magnifier of FIG. 1 showing the notch of the blade holder with and without a blade.

FIGS. 3A and 3B show variants of embodiments of the lug formed in the notch of the blade holder of the device according to the invention.

### DESCRIPTION OF THE EMBODIMENTS

The invention concerns the automatic cutting of a flexible material by a vibrating blade of a cutting machine, in particular by a steel blade, for example high-speed steel.

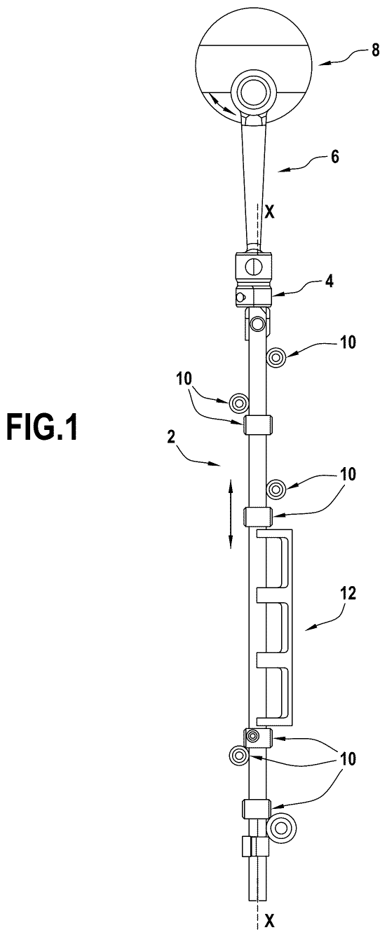

As schematically represented in FIG. 1, the blade 2 of such a cutting machine is typically assembled on a blade holder 4 of the cutting head and is vibrated vertically along the direction of its sharp edge in order to cut the material.

The blade 2 is for example vibrated by a connecting rod 6—crank 8 system which drives the blade in a back-and-forth translational movement along the direction of the longitudinal axis X-X of the blade.

Moreover, the blade 2 is guided in its translational movement by a set of rollers 10 distributed over any height. These rollers 10 also make it possible to partly absorb the forces due to cutting.

Furthermore, a rotating blade guide 12 serves as a slide for the blade 2 and ensures its rotation about its longitudinal axis X-X.

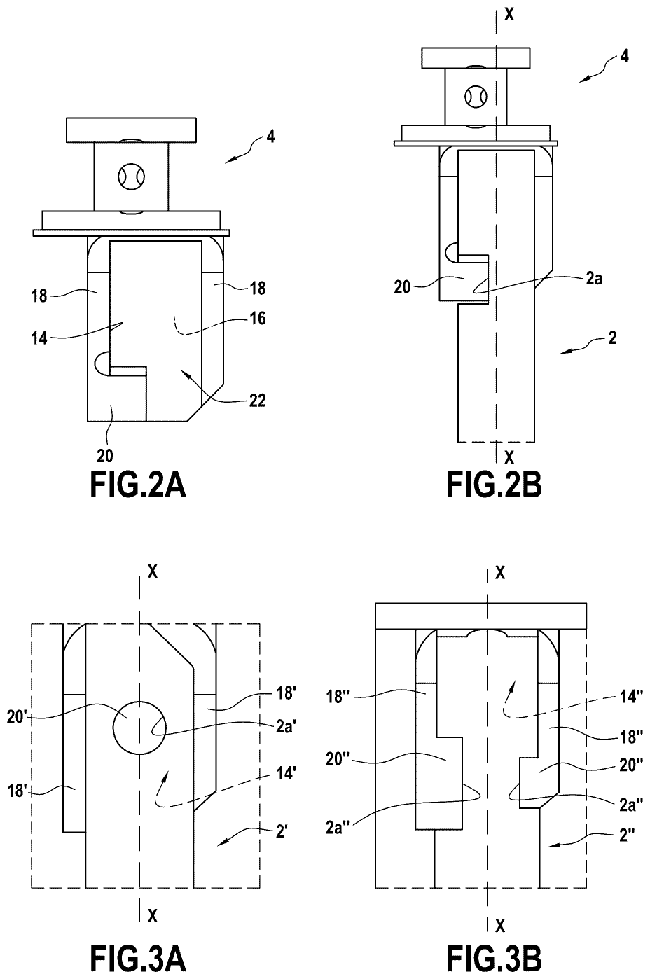

As represented more specifically in FIGS. 2A and 2B, the blade holder 4 has a notch 14 which is able to receive an upper end of the blade 2.

For example, this notch 14 is of substantially rectangular shape and can comprise a bottom 16 having a substantially planar surface and is delimited laterally by two rims 18 which are protruding relative to the bottom 16 and which extend along the longitudinal axis X-X of the blade.

Of course, it is possible to envisage other geometries for the shape of the notch intended to receive the upper end of the blade.

Moreover, still according to the invention, a lug 20 is formed in the notch 18. In the exemplary embodiment of FIGS. 2A and 2B, this lug 20 extends from a lower end of one of the lateral rims 18 of the notch towards the other rim along a direction substantially perpendicular to the longitudinal axis X-X of the blade.

The upper end of the blade 2 according to the invention comprises a cutout 2a having a shape substantially complementary to that of the lug 20 (in the example of FIGS. 2A and 2B, the lug and the cutout of the blade have a substantially rectangular shape).

This shape complementarity between the lug and the notch of the blade forms a key to avoid an error when mounting the blade on the blade holder. This shape complementarity also ensures an absorption of the cutting forces of the blade.

Still according to the invention, at least one magnet 22 is assembled inside the notch 14 in order to establish a planar bearing with a corresponding planar surface of the upper end of the blade and to ensure holding by magnetism of the upper end of the blade in the notch of the blade holder.

The number, shape and arrangement of the magnet(s) assembled inside the notch of the blade holder may vary depending on the applications and the shape of the notch.

Likewise, different types of magnets can be used. For example, it is possible to choose a magnet made from neodymium boron or from a samarium-cobalt alloy or from any other ferrite. The magnet(s) can be bonded to the bottom of the notch.

The holding of the blade 2 in the notch 14 of the blade holder 4 is thus obtained by magnetism without resorting to any mechanical attachment (of the screw type for example).

In relation to FIGS. 3A and 3B, variants of embodiments of the lug formed in the notch of the blade holder of the device according to the invention will now be described.

In the variant of embodiment of [FIG. 3A], the notch 14′ of the blade holder is of substantially rectangular shape and is delimited laterally by two rims 18′ which are protruding relative to the bottom of the bottom of the notch and which extend along the longitudinal axis X-X of the blade.

Moreover, in this variant of embodiment, the lug is made by a pin 20′ which extends from the bottom of the notch 14′ along a direction substantially perpendicular to the longitudinal axis of the blade. For example, the pin 20′ is centered on the longitudinal axis X-X of the blade.

As for the blade 2′, it has a cutout 2a′ which has a shape complementary to the pin 20′, that is to say a cutout of circular shape.

This variant of embodiment has the advantage that the blade is easy to machine in order to make the cut 2a′. On the other hand, the shape of the pin does not ensure a key function.

In the variant of embodiment of [FIG. 3B], the notch 14″ of the blade holder is also of substantially rectangular shape and is delimited laterally by two rims 18″ which are protruding relative to the bottom of the notch and which extend along the longitudinal axis X-X of the blade.

Moreover, in this variant of embodiment, the lug is double and each lug 20″ extends from a lower end of one of the lateral rims 18″ of the notch towards the other rim along a direction substantially perpendicular to the longitudinal axis X-X of the blade.

Of course, the upper end of the blade 2″ has two cutouts 2a″ of shapes complementary to the two lugs 20″ of the notch.

The presence of two lugs has the advantage of ensuring excellent absorption of the cutting forces. On the other hand, the contact surface with the magnets can be restricted and the final assembly presents a risk of hyperstatism.

Moreover, it will be noted that other means for holding by magnetism the upper end of the blade in the notch of the blade holder can be envisaged.

Thus, in one variant of embodiment not represented in the figures, the notch of the blade holder can be magnetized so as to ensure holding by magnetism of the upper end of the blade in the notch of the blade holder.

Alternatively, in another variant of embodiment not represented in the figures, the notch of the blade holder can comprise a ferromagnetic metal and the upper end of the blade can comprise a magnet so as to ensure holding by magnetism of the upper end of the blade in the notch of the blade holder.

1.-11. (canceled)

12. A device for holding a vibrating steel blade on a blade holder of a cutting machine, comprising:
a vibrating steel blade for a cutting machine;
a blade holder having a notch able to receive an upper end of the blade,
means for holding by magnetism the upper of the blade in the notch of the blade holder along a direction perpendicular to a longitudinal axis of the blade, and
at least one lug formed in the notch and able to be housed in a cutout made in the upper end of the blade in order to ensure an absorption of the cutting forces.

13. The device according to claim 12, wherein the blade holder comprises at least one magnet assembled inside the notch and able to establish a planar bearing with a planar surface of the upper end of the blade so as to ensure holding by magnetism of the upper end of the blade in the notch of the blade holder.

14. The device according to claim 12, wherein the notch of the blade holder is magnetized so as to ensure holding by magnetism of the upper end of the blade in the notch of the blade holder.

15. The device according to claim 12, wherein the notch of the blade holder comprises a ferromagnetic metal and the upper end of the blade comprises a magnet so as to ensure holding by magnetism of the upper end of the blade in the notch of the blade holder.

16. The device according to claim 12, wherein the notch comprises a bottom having a planar surface and is delimited laterally by two rims protruding relative to the bottom.

17. The device according to claim 16, wherein the lug extends from a lower end of one of the rims of the notch towards the other rim along a direction substantially perpendicular to the longitudinal axis of the blade.

18. The device according to claim 16, wherein the lug is made by a pin extending from the bottom of the notch along a direction substantially perpendicular to the longitudinal axis of the blade.

19. The device according to claim 16, wherein the holding of the blade in the notch of the blade holder is devoid of mechanical attachment.

20. A vibrating steel blade for a cutting machine intended to cooperate with the holding device according to claim 12, comprising an upper end able to house in the notch of the blade holder and to be held therein by the magnetism holding means, the upper end of the blade comprising at least one cutout able to receive the lug formed in the notch.

21. A blade according to claim 20, wherein it is made of high-speed steel.

22. An assembly of a vibrating steel blade according to claim 20 on a blade holder of a cutting machine via a holding device.
